(19) United States
(12) Patent Application Publication
(10) Pub. No.: US 2009/0258307 A1
(43) Pub. Date: Oct. 15, 2009

(54) DEVELOPER AND IMAGE FORMING APPARATUS

(75) Inventor: Hiroshi Kawaguchi, Kanagawa (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/418,723

(22) Filed: Apr. 6, 2009

Related U.S. Application Data
(60) Provisional application No. 61/044,220, filed on Apr. 11, 2008.

(51) Int. Cl. G03G 9/00; G03G 15/08

(52) U.S. Cl. 430/108.1; 399/252; 430/108.7

(57) ABSTRACT

A developer used in an image forming apparatus, the developer containing: a toner, and a carrier that charges the toner, the toner containing a core toner, and an external additive that is added to a surface of the core toner, the core toner containing a colorant, a binder resin, a releasing agent, and a charge controlling agent containing Al and Mg, an amount of the charge controlling agent on the surface of the core toner being from 0.2 to 4.0 cps/eV in terms of a Mg amount measured by EDX, the core toner having a circularity of from 0.880 to 0.930, the external additive having a primary particle diameter of from 70 to 200 nm, an amount of the external additive being from 0.2 to 3.0% by weight based on the core toner.

### CROSS-REFERENCE TO RELATED APPLICATION

This application is based upon and claims the benefit of priority from the prior U.S. Patent Application 61/044,220 filed on Apr. 11, 2008, the entire contents of which are incorporated herein by reference.

### TECHNICAL FIELD

The present invention relates to a developer used on forming an image by an electrophotographic system, such as a duplicator and a printer.

### BACKGROUND

In an image forming apparatus using an electrophotographic system, a two-component developer containing a toner and a magnetic carrier charging the toner is used. In the two-component developer, the carrier is deteriorated through the use of the developer, and it is thus difficult to maintain the initial state, such as the intended charging property, for achieving a prolonged service life.

For example, decrease in charging property through the use for a prolonged period brings about such a problem that a toner suffering charging failure contaminates the interior of the apparatus, thereby causing severe image failure and fogged images.

Under the circumstances, various attempts for enhancing the service life of the developer are being studied, such as optimization of the core material or the coating material and the production method of a carrier, and optimization of the formulation and the production method of the toner, thereby enhancing the capabilities of the developer, such as the charging property thereof.

Various studies are being made on optimization of a charge controlling agent, which is added to a toner for enhancing the charging property of the toner. For example, US 2005/0277040A1 discloses a charge controlling agent containing Al and Mg. However, even though the charge controlling agent is added to a toner, the charge amount fluctuates depending on fluctuation of the environment, where the apparatus is installed, and thus it is difficult to control the charging property appropriately. For example, although the charge amount can be suppressed from being lowered under a high humidity condition, the charge amount is problematically increased under a low humidity condition.

### SUMMARY

The invention relates to, according to one embodiment thereof, a developer containing: a toner, and a carrier that charges the toner; the toner containing a core toner, and an external additive that is added to a surface of the core toner; the core toner containing a colorant, a binder resin, a releasing agent, and a charge controlling agent containing Al and Mg, an amount of the charge controlling agent on the surface of the core toner being from 0.2 to 4.0 cps/eV in terms of a Mg amount measured by EDX, the core toner having a circularity of from 0.880 to 0.920; the external additive having a primary particle diameter of from 70 to 200 nm, an amount of the external additive being from 0.2 to 3.0% by weight based on the core toner.

The invention also relates to, according to another embodiment thereof, a developer containing: a toner, and a carrier that charges the toner; the toner containing a core toner, and an external additive that is added to a surface of the core toner; the core toner containing a colorant, a binder resin, a releasing agent, and a charge controlling agent containing Al and Mg, an amount of the charge controlling agent on the surface of the core toner being from 1.0 to 3.0 cps/eV in terms of a Mg amount measured by EDX, the core toner having a circularity of from 0.900 to 0.920; the external additive having a primary particle diameter of from 100 to 120 nm, an amount of the external additive being from 0.5 to 2.0% by weight based on the core toner.

The invention also relates to, according to still another embodiment thereof, an image forming apparatus containing: an image carrying member, on which an electrostatic latent image is formed, and a developing device that houses a developer containing a toner that develops the electrostatic latent image on the image carrying member, and a carrier that charges the toner;

the toner containing a core toner, and an external additive that is added to a surface of the core toner; the core toner containing a colorant, a binder resin, a releasing agent, and a charge controlling agent containing Al and Mg, an amount of the charge controlling agent on the surface of the core toner being from 0.2 to 4.0 cps/eV in terms of a Mg amount measured by EDX, the core toner having a circularity of from 0.880 to 0.930; the external additive having a primary particle diameter of from 70 to 200 nm, an amount of the external additive being from 0.2 to 3.0% by weight based on the core toner.

It is to be understood that both the foregoing general description and the following detailed description are exemplary and explanatory only and are not restrictive of the invention, as claimed.

### DESCRIPTION OF THE DRAWINGS

The accompanying drawings, which are incorporated in and constitute a part of the present specification, illustrate embodiments of the invention and together with description, serve to explain the principles of the invention

FIG. 1 is a schematic illustration showing a constitution of an image forming apparatus according to an embodiment of the invention.

FIG. 2 is a table showing compositions of developers of Examples according to an embodiment of the invention and Comparative Examples, and evaluation results of the developers.

### DETAILED DESCRIPTION

Reference will be now be made in detail to the present embodiment of the invention, an example of which is illustrated in the accompanying drawings.

A developer of the embodiment contains a toner, and a carrier that charges the toner. The toner contains a core toner, and an external additive that is added to a surface of the core toner. The core toner contains a colorant, a binder resin, a releasing agent, and a charge controlling agent containing Al and Mg. The amount of the charge controlling agent on the surface of the core toner is from 0.2 to 4.0 cps/eV in terms of a Mg amount measured by EDX, and the core toner has a circularity of from 0.880 to 0.930. The external additive has a primary particle diameter of from 70 to 200 nm, and the amount of the external additive is from 0.2 to 3.0% by weight based on the core toner.

Examples of the colorant used in the core toner include carbon black, a yellow pigment that is ordinarily used in a toner, such as P.Y. 180, P.Y. 74, P.Y. 17, P.Y. 185 and P.Y. 93, a magenta pigment that is ordinarily used in a toner, such as P.R. 122, P.R. 185, P.R. 57:1, P.R. 31, P.R. 238, P.R. 269, P.R. 146, P.R. 147, P.R. 184 and P.V. 19, and a cyan pigment that is ordinarily used in a toner, such as P.B. 15 and P.G. 7.

Examples of the binder resin used in the core toner include a polyester resin, a styrene-acrylic resin and a resin containing both of them.

The polyester resin is obtained from a monomer containing an acid component containing polybasic carboxylic acid compound having a valency of 2 or more and a monomer containing an alcohol component containing polyhydric alcohol compound having a valency of 2 or more.

Examples of the acid component include fumaric acid, maleic acid, citraconic acid, itaconic acid, glutaconic acid, phthalic acid, isophthalic acid, terephthalic acid, cyclohexanedicarboxylic acid, succinic acid, adipic acid, sebacic acid, azelaic acid, malonic acid, succinic acid substituted with an alkyl group having from 1 to 20 carbon atoms or an alkenyl group having from 2 to 20 carbon atoms, such as dodecenylsuccinic acid and octylsuccinic acid, and an anhydride and a derivative of an alkylester and the like, of these acids.

Examples of the alcohol component include an aliphatic polyol, such as ethylene glycol, propylene glycol, 1,4-butanediol, 1,3-butanediol, 1,5-pentanediol, 1,6-hexanediol, neopentyl glycol, glycerin, trimethylolethane, trimethylolpropane and pentaerythritol, an alicyclic polyol, such as 1,4-cyclohexanediol and 1,4-cyclohexanedimethanol, an ethylene oxide or propylene oxide adduct of bisphenol A and the like.

Examples of the styrene-acrylic resin include a polymer of a styrene compound, a copolymer of a styrene compound and a diene compound, and a copolymer of a styrene compound and an alkyl (meth)acrylate.

Examples of the releasing agent include natural wax, such as carnauba wax and rice wax, and synthetic wax, such as polypropylene and polyethylene.

The core toner further contains a charge controlling agent (CCA) for controlling the frictional charge amount (charge amount), such as a metal-containing azo compound, a metal-containing salicylic acid compound and a metallic oxide treated to have hydrophobicity, which contains Al and Mg. The charge controlling agent maintains, owing to Al and Mg contained, high charging property to suppress the charge amount from being decreased with the lapse of time. The charge controlling agent may further contain, in addition to Al and Mg, one or more of Fe, Cr and Zr as a metallic element. At least one charge controlling agent other than one defined above may be used in combination.

The core toner containing the colorant, the binder resin, the releasing agent and the charge controlling agent necessarily has a circularity of from 0.880 to 0.930. The circularity can be obtained, for example, with a flow type particle image analyzer, such as EPIA-2100, produced by Sysmex Corporation.

Specifically, a suspension liquid having toner particles suspended in an aqueous solution is passed through a gap of 200 μm between two transparent parallel plates of a cell to form a flat suspension liquid flow. The suspension liquid flow is irradiated with stroboscopic light with an interval of 1/30 second, and toner particles in the suspension liquid that are passed through the cell are imaged as a still image with a CCD camera through an objective lens. The still image is subjected to image analysis, and the circularity is calculated from the projected area and the circumferential length of the particle image.

When the circularity is less than 0.880, a local highly-charged area is excessively formed, whereby the image density becomes short, and the transferring property is deteriorated, under a low temperature and low humidity condition. When the circularity exceeds 0.930, a local highly-charged area cannot be sufficiently formed, whereby sufficient charging property cannot be obtained due to deterioration of the developer, which causes fogging and scatter of the toner. The circularity of the core toner is more preferably from 0.900 to 0.920.

The amount of the CCA on the surface of the core toner is necessarily from 0.2 to 4.0 cps/eV in terms of a Mg amount measured by EDX (energy dispersive X-ray Spectroscopy).

In the measurement, specifically, EDX QX400, produced by Bruker Japan Co., Ltd., is used, for example, and the measurement conditions are set to a magnification of 25,000, HV (high voltage) of 7.0 kV and WD (working distance) of 8.2 mm. The external additives on the surface of the core toner are each measured to find an area having no external additive containing Mg present, and the area (preferably an area having no external additive present on the surface of the core toner) is measured for Mg amount.

When the amount of the CCA is less than 0.2 cps/eV, sufficient charging power cannot be obtained to fail to provide sufficient charging property due to deterioration of the developer, thereby causing fogging and scatter of the toner. When the amount of the CCA exceeds 4.0 cps/eV, excessive charging occurs to cause short in image density under a low temperature and low humidity environment. The amount of the CCA is preferably from 1.0 to 3.0 cps/eV.

The amount of the CCA added is preferably from 0.5 to 2 parts by weight per 100 parts by weight of the binder resin. When the amount is less than 0.5 part by weight, sufficient charging property may not be imparted, and when the amount exceeds 2 parts by weight, the charge amount is excessively increased particularly in a low humidity condition. The amount of the CCA added is more preferably from 0.7 to 1.5 parts by weight.

The external additive having a primary particle diameter of from 70 to 200 nm is added to the surface of the core toner. The presence of the inorganic oxide having a relatively large particle diameter on the surface of the core toner provides a spacing effect. A spent phenomenon, i.e., attachment of components of the toner onto the surface of the carrier, occurs upon use of the developer for a prolonged period of time, and alters the characteristics of the carrier. The spacing effect can suppress the carrier characteristics from being altered by the spent phenomenon.

When the primary particle diameter of the inorganic oxide having a large particle diameter as the external additive is less than 70 nm or exceeds 200 nm, a suitable spacing effect cannot be obtained to lower the charging property, whereby a sufficient image density cannot be obtained, and fogging occurs. The primary particle diameter of the external additive is more preferably from 100 to 120 nm.

The external additive is necessarily contained in an amount of from 0.2 to 3.0% by weight based on the core toner. When the content of the external additive is less than 0.2% by weight, a sufficient spacing effect may not be obtained to deteriorate the developing property. When the content thereof exceeds 3.0% by weight, the fixing property is deteriorated. The content of the external additive is more preferably from 0.5 to 2.0% by weight.

The external additive used may be an oxide containing a metal, such as Ti, Si, Al, St, Fe, Mn, Zn and Cu, which is ordinarily used in a toner, produced by a calcined method or a wet method. Specific examples thereof include silica, titanium oxide, alumina, strontium titanate, tin oxide, and among these, silica and titanium oxide are preferably used.

A lubricating agent for a drum cleaner is preferably externally added to the surface of the core toner. Examples of the lubricating agent include a higher fatty acid salt of Zn, Ca, Mg, Al or the like (metallic soap) and a resin containing fluorine. An inorganic oxide having a small primary particle diameter of about from 8 to 50 nm may be added for enhancing the flowability of the toner.

The core toner preferably has a volume average particle diameter of from 3 to 7 μm. When the volume average particle diameter is less than 3 μm, the charge amount per unit volume is excessively increased upon imparting such a charge amount to the toner particles that can control the electric field, thereby making difficult to provide an intended developing amount. When the volume average particle diameter exceeds 7 μm, a high definition image may be deteriorated in reproducibility and granularity. The volume average particle diameter of the core toner is more preferably from 4 to 6 μm.

Examples of the carrier contained in the developer for charging the toner include magnetic particles, such as ferrite, magnetite and iron oxide, and resin particles having the magnetic powder mixed therein. The carrier may have a resin coating layer formed on the surface thereof.

The carrier preferably has a particle diameter of from 20 to 50 μm. When the particle diameter of the carrier is less than 20 μm, the carrier is liable to be dropped off from a developer carrying member due to a small magnetic force per one particle, and attached to the photoreceptor. When the particle diameter exceeds 50 μm, a brush mark may be formed on an image, and the toner may not be precisely fed, due to a hard magnetic brush formed. The particle diameter of the carrier is more preferably from 25 to 40 μm.

The developer constituted by the toner and the carrier mentioned above ensures high charging property even when the carrier is deteriorated in the image formation process, thereby prolonging the service life of the developer.

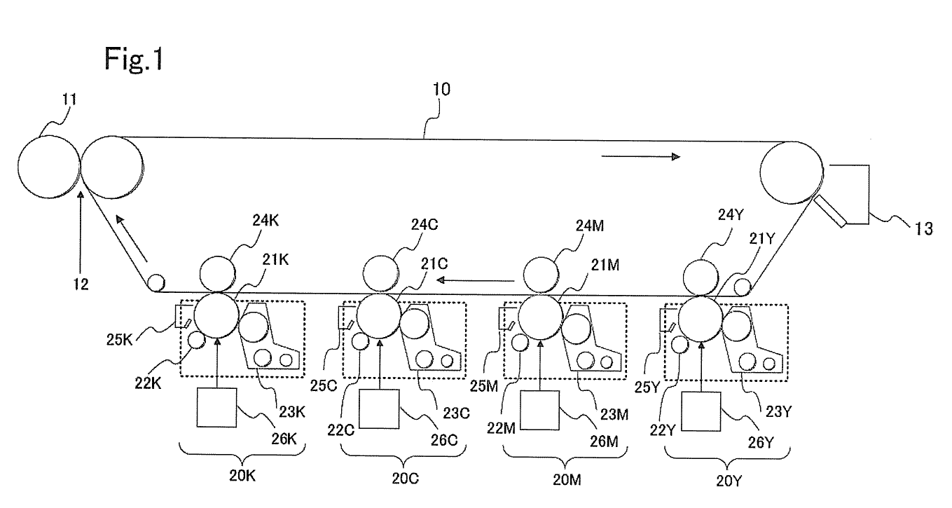

The developer according to the embodiment can be applied, for example, to an image formation process, such as a four-step tandem electrophotographic process described below. FIG. 1 is a schematic illustration showing a constitution of a color printer, which is a four-step tandem image forming apparatus according the embodiment. As shown in FIG. 1, image forming units 20Y, 20M, 20C and 20K are disposed along the conveying direction (shown by the arrow in the figure) of an intermediate transfer belt 10.

The image forming units 20Y, 20M, 20C and 20K each have photoconductive drums 21Y, 21M, 21C and 21K as an image carrying member (electrostatic latent image carrying member), respectively. Examples of the photoconductor drum used include a known photoconductive material, such as a positively charging or negatively charging OPC (organic photoconductor) and amorphous silicon.

The image forming units 20Y, 20M, 20C and 20K each have, around each of the photoconductive drums, charging device 22Y, 22M, 22C or 22K as a charging unit, a developing roller as a developing member, and the like, and each are also equipped with a developing device 23Y, 23M, 23C or 23K housing a developer containing toner particles of yellow, magenta, cyan or black and carrier particles, a primary transfer roller 24Y, 24M, 24C or 24K as a transferring unit, and a cleaner 25Y, 25M, 25C or 25K as a cleaning unit. These units are disposed along the rotation direction of the corresponding photoconductor drums 21Y, 21M, 21C and 21K, respectively.

The primary transfer rollers 24Y, 24M, 24C and 24K each are disposed inside the intermediate transfer belt 10, and each hold the intermediate transfer belt 10 with the corresponding photoconductor drums 21Y, 21M, 21C and 21K, respectively. Exposing devices 26Y, 26M, 26C and 26K are disposed in such a manner that exposing points are formed on the outer surface of the photoconductive drums 21Y, 21M, 21C and 21K between the charging devices 22Y, 22M, 22C and 22K and the developing devices 23Y, 23M, 23C and 23K, respectively. A secondary transfer roller 11 is disposed outside and in contact with the intermediate transfer belt 10.

An image is formed with the image forming apparatus in the following manner. The photoconductor drum 21Y is uniformly charged negatively (−) with the charging device 22Y. The photoconductor drum 21Y thus charged is exposed according to image information with the exposing device 26Y to form an electrostatic latent image.

The electrostatic latent image on the photoconductor drum 21Y is reversely developed with a developer in the developing device 23Y to form a toner image on the photoconductor drum 21Y.

A bias that has an opposite polarity (+) to the charging polarity of the toner is applied to the primary transfer roller 24Y with an electric power source (which is not shown in the figure), thereby forming a transfer electric field between the photoconductor drum 21Y and the primary transfer roller 24Y. As a result, the toner image on the photoconductor drum 21Y is primarily transferred to the transfer belt 10 with the transfer electric field upon passing between the photoconductor drum 21Y and the primary transfer roller 24Y. The photoconductor drum 21Y after transferring is cleaned with the cleaner 25Y and then again subjected to the process including charging, exposing and developing.

A toner image is thus formed in the image forming unit 20Y. The same process is performed in each of the image forming units 20M, 20C and 20K in synchronization with the formation of the toner image in the image forming unit 20Y. The toner images of magenta, cyan and black formed on the photoconductor drums of the image forming units 20M, 20C and 20K are also sequentially primarily transferred to the intermediate transfer belt 10.

A transfer medium 12 is conveyed from a cassette (which is not shown in the figure) and fed to the intermediate transfer belt 10 with an aligning roller (which is not shown in the figure) in synchronization with the toner images on the intermediate transfer belt 10.

A bias that has an opposite polarity (+) to the charging polarity of the toner is applied to the secondary transfer roller 11 with an electric power source (which is not shown in the figure). Accordingly, the toner images on the intermediate transfer belt 10 are transferred onto the transfer medium 12 with the transfer electric field formed between the intermediate transfer belt 10 and the secondary transfer roller 11. The image forming apparatus is provided with a fixing device (which is not shown in the figure) for fixing the toner transferred onto the transfer medium 12, a fixed image can be obtained by passing the transfer medium 12 through the fixing device.

The toner that is not completely transferred to the transfer medium 12 but remains partially on the transfer belt (untransferred toner) is cleaned with a cleaner 13.

In the examples referred herein, the image forming units of yellow, magenta, cyan and black are aligned in this order, but the order of the colors is not particularly limited. Upon using a cleanerless process using no cleaner, the untransferred toner is recovered simultaneously with development.

The invention will be described in more detail with reference to examples below.

### Example 1

To a polyester resin, 4% by weight of carnauba wax as a releasing agent, 5% by weight of carbon black as a colorant and 1.5% by weight of CCA containing Al and Mg, all based on the polyester resin, are mixed with a Henschel mixer. The mixture is then kneaded with an extrusion melt kneader, and pulverized and classified under prescribed conditions to provide a core toner having a circularity of 0.915 and an amount of the CCA of 1 cps/eV in terms of a Mg amount measured by EDX.

Silica having a primary particle diameter of 100 nm as an external additive is added to the core toner in an amount of 1.50% by weight based on the core toner. 1.0% by weight of titanium oxide having a primary particle diameter of 20 nm for enhancing the flowability of the toner and 0.1% by weight of a metallic soap as a lubricant for a drum cleaner are added to the core toner, and they are externally added thereto by mixing with a Henschel mixer for a prescribed period of time, thereby providing a toner.

A ferrite carrier is added to the toner to make a carrier concentration of 92% by weight, thereby preparing a developer. The developer is evaluated in the following manners. The evaluations are performed with a multifunction peripheral, e-STUDIO 103500C, produced by Toshiba Corporation, under a test environment adjusted to a temperature of from 20 to 25° C. and a humidity of from 40 to 60%. 300,000 sheets of A4-size paper are continuously printed at a print ratio of 8%, and then the following evaluations are performed.

### (Evaluation of Fogging)

A fogging rate of a duplicate on A3 white paper is measured with Photovolt. Less than 2% is evaluated as “passed”, and 2% or more is evaluated as “failed”.

### (Evaluation of Scatter of Toner)

One suffering no contamination, such as fall of the toner and the like, due to scattering of the toner confirmed is evaluated as “passed”, and one suffering the contamination was evaluated as “failed”.

### (Evaluation of Image Density)

A solid image is printed after allowing to stand in a controlled environment of a temperature of 10° C. and a humidity of 20% for 24 hours. The density of the printed image is measured with Macbeth Model 191. A value of 1.3 or more is evaluated as “passed”, and a value less than 1.3 is evaluated as “failed”.

### (Evaluation of Transferring Property)

The developing potential is controlled to a toner amount of 0.5 mg/cm² on the photoconductor drum, and the untransferred toner amount on the photoconductor drum is measured. A transfer rate of 95% or more based on 0.5 mg/cm² before transfer is evaluated as “passed”, and a transfer rate of less than 95% is evaluated as “failed”.

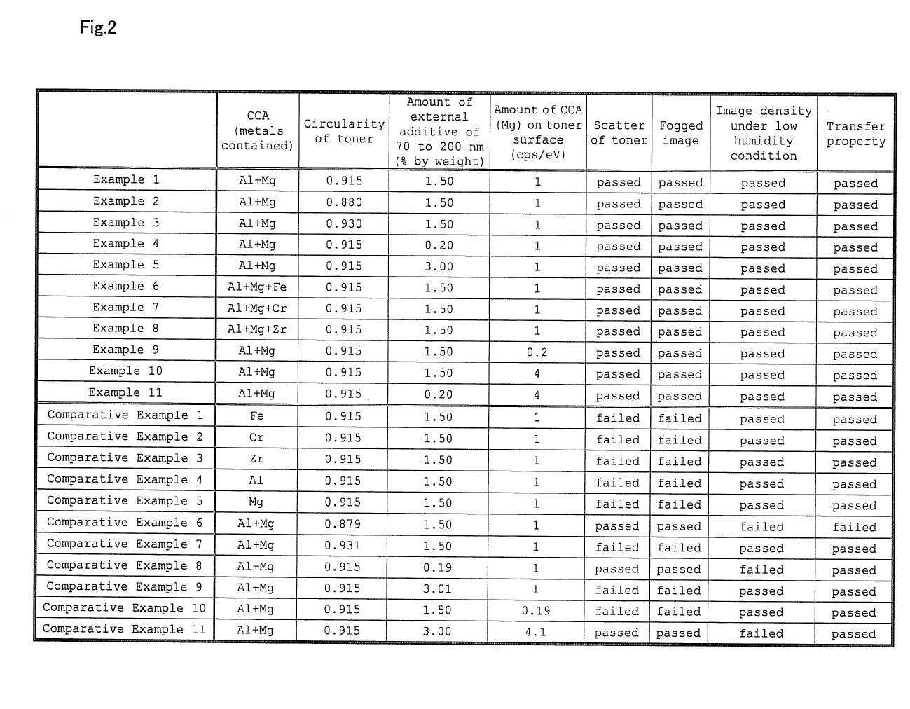

As shown in FIG. 2, the developer of this example exhibits good characteristics in all the evaluations.

### Example 2

A developer is prepared in the same manner as in Example 1 except that the circularity of the core toner is 0.880, and evaluated in the same manner as in Example 1. As shown in FIG. 2, the developer of this example exhibits good characteristics in all the evaluations.

### Example 3

A developer is prepared in the same manner as in Example 1 except that the circularity of the core toner is 0.930, and evaluated in the same manner as in Example 1. As shown in FIG. 2, the developer of this example exhibits good characteristics in all the evaluations.

### Example 4

A developer is prepared in the same manner as in Example 1 except that silica having a primary particle diameter of 100 nm as an external additive is added in an amount of 0.20% by weight based on the core toner, and evaluated in the same manner as in Example 1. As shown in FIG. 2, the developer of this example exhibits good characteristics in all the evaluations.

### Example 5

A developer is prepared in the same manner as in Example 1 except that silica having a primary particle diameter of 100 nm as an external additive is added in an amount of 3.00% by weight based on the core toner, and evaluated in the same manner as in Example 1. As shown in FIG. 2, the developer of this example exhibits good characteristics in all the evaluations.

### Example 6

A developer is prepared in the same manner as in Example 1 except that CCA containing Fe, in addition to Al and Mg, as metals contained is used, and evaluated in the same manner as in Example 1. As shown in FIG. 2, the developer of this example exhibits good characteristics in all the evaluations.

### Example 7

A developer is prepared in the same manner as in Example 1 except that CCA containing Cr, in addition to Al and Mg, as metals contained is used, and evaluated in the same manner as in Example 1. As shown in FIG. 2, the developer of this example exhibits good characteristics in all the evaluations.

### Example 8

A developer is prepared in the same manner as in Example 1 except that CCA containing Zr, in addition to Al and Mg, as metals contained is used, and evaluated in the same manner as in Example 1. As shown in FIG. 2, the developer of this example exhibits good characteristics in all the evaluations.

### Example 9

A developer is prepared in the same manner as in Example 1 except that the amount of the CCA on the surface of the core toner is 0.2 cps/eV in terms of a Mg amount measured by EDX, and evaluated in the same manner as in Example 1. As shown in FIG. 2, the developer of this example exhibits good characteristics in all the evaluations.

### Example 10

A developer is prepared in the same manner as in Example 1 except that the amount of the CCA on the surface of the core toner is 4.0 cps/eV in terms of a Mg amount measured by EDX, and evaluated in the same manner as in Example 1. As shown in FIG. 2, the developer of this example exhibits good characteristics in all the evaluations.

### Example 11

A developer is prepared in the same manner as in Example 10 except that silica having a primary particle diameter of 100 nm as an external additive is added in an amount of 0.20% by weight based on the core toner, and evaluated in the same manner as in Example 1. As shown in FIG. 2, the developer of this example exhibits good characteristics in all the evaluations.

### Comparative Example 1

A developer is prepared in the same manner as in Example 1 except that CCA containing only Fe as a metal contained is used, and evaluated in the same manner as in Example 1. As shown in FIG. 2, the developer of this comparative example suffers scatter of the toner and fogged image due to the absence of Al and Mg, while it is good in image density under a low humidity condition and transfer property.

### Comparative Example 2

A developer is prepared in the same manner as in Example 1 except that CCA containing only Cr as a metal contained is used, and evaluated in the same manner as in Example 1. As shown in FIG. 2, the developer of this comparative example suffers scatter of the toner and fogged image due to the absence of Al and Mg, while it is good in image density under a low humidity condition and transfer property.

### Comparative Example 3

A developer is prepared in the same manner as in Example 1 except that CCA containing only Zr as a metal contained is used, and evaluated in the same manner as in Example 1. As shown in FIG. 2, the developer of this comparative example suffers scatter of the toner and fogged image due to the absence of Al and Mg, while it is good in image density under a low humidity condition and transfer property.

### Comparative Example 4

A developer is prepared in the same manner as in Example 1 except that CCA containing only Al as a metal contained is used, and evaluated in the same manner as in Example 1. As shown in FIG. 2, the developer of this comparative example suffers scatter of the toner and fogged image due to the absence of Mg, while it is good in image density under a low humidity condition and transfer property.

### Comparative Example 5

A developer is prepared in the same manner as in Example 1 except that CCA containing only Mg as a metal contained is used, and evaluated in the same manner as in Example 1. As shown in FIG. 2, the developer of this comparative example suffers scatter of the toner and fogged image due to the absence of Al, while it is good in image density under a low humidity condition and transfer property.

### Comparative Example 6

A developer is prepared in the same manner as in Example 1 except that the circularity of the core toner is 0.879, and evaluated in the same manner as in Example 1. As shown in FIG. 2, the developer of this comparative example is deteriorated in image density under a low humidity condition and transfer property due to the low circularity of core toner, while scatter of the toner and fogged image are not observed.

### Comparative Example 7

A developer is prepared in the same manner as in Example 1 except that the circularity of the core toner is 0.931, and evaluated in the same manner as in Example 1. As shown in FIG. 2, the developer of this comparative example suffers scatter of the toner and fogged image due to the high circularity, while it is good in image density under a low humidity condition and transfer property.

### Comparative Example 8

A developer is prepared in the same manner as in Example 1 except that silica having a primary particle diameter of 100 nm as an external additive is added in an amount of 0.19% by weight based on the core toner, and evaluated in the same manner as in Example 1. As shown in FIG. 2, the developer of this comparative example is deteriorated in image density under a low humidity condition due to too small the amount of the external additive added, while it does not suffer scatter of the toner and fogged image, and is good in transfer property.

### Comparative Example 9

A developer is prepared in the same manner as in Example 1 except that silica having a primary particle diameter of 100 nm as an external additive is added in an amount of 3.01% by weight based on the core toner, and evaluated in the same manner as in Example 1. As shown in FIG. 2, the developer of this comparative example suffers scatter of the toner and fogged image due to too large the amount of the external additive added, while it is good in image density under a low humidity condition and transfer property.

### Comparative Example 10

A developer is prepared in the same manner as in Example 1 except that the amount of the CCA on the surface of the core toner is 0.19 cps/eV in terms of a Mg amount measured by EDX, and evaluated in the same manner as in Example 1. As shown in FIG. 2, the developer of this comparative example suffers scatter of the toner and fogged image due to too small the amount of the CCA on the surface of the core toner, while it is good in image density under a low humidity condition and transfer property.

### Comparative Example 11

A developer is prepared in the same manner as in Example 1 except that silica having a primary particle diameter of 100 nm as an external additive is added in an amount of 0.19% by weight based on the core toner and that the amount of the CCA on the surface of the core toner is 4.1 cps/eV in terms of a Mg amount measured by EDX, and evaluated in the same manner as in Example 1. As shown in FIG. 2, the developer of this comparative example is deteriorated in image density under a low humidity condition due to too large the amount of the CCA on the surface of the core toner, while it does not suffer scatter of the toner and fogged image, and is good in transfer property.

Other embodiments of the invention will be apparent to those skilled in the art from consideration of the specification and practice of the invention disclosed herein. It is intended that the specification and examples to be considered as exemplary only, with a true scope and spirit of the invention being indicated by the following claims.

What is claimed is:

1. A developer comprising:
a toner, and a carrier to charge the toner,
the toner containing a core toner, and an external additive added to a surface of the core toner,
the core toner containing a colorant, a binder resin, a releasing agent, and a charge controlling agent containing Al and Mg, an amount of the charge controlling agent on the surface of the core toner being from 0.2 to 4.0 cps/eV in terms of a Mg amount measured by EDX, the core toner having a circularity of from 0.880 to 0.930,
the external additive having a primary particle diameter of from 70 to 200 nm, an amount of the external additive being from 0.2 to 3.0% by weight based on the core toner.

2. The developer according to claim 1, wherein the core toner has a circularity of from 0.900 to 0.920.

3. The developer according to claim 1, wherein the amount of the charge controlling agent on the surface of the core toner is from 1.0 to 3.0 cps/eV in terms of a Mg amount measured by EDX.

4. The developer according to claim 1, wherein the external additive has a primary particle diameter of from 100 to 120 nm.

5. The developer according to claim 1, wherein the amount of the external additive is from 0.5 to 2.0% by weight based on the core toner.

6. The developer according to claim 1, wherein the external additive contains silica.

7. The developer according to claim 1, wherein the charge controlling agent further contains Fe.

8. The developer according to claim 1, wherein the charge controlling agent further contains Cr.

9. The developer according to claim 1, wherein the charge controlling agent further contains Zr.

10. A developer comprising:
a toner, and a carrier to charge the toner,
the toner containing a core toner, and an external additive added to a surface of the core toner,
the core toner containing a colorant, a binder resin, a releasing agent, and a charge controlling agent containing Al and Mg, an amount of the charge controlling agent on the surface of the core toner being from 1.0 to 3.0 cps/eV in terms of a Mg amount measured by EDX, the core toner having a circularity of from 0.900 to 0.920,
the external additive having a primary particle diameter of from 100 to 120 nm, an amount of the external additive being from 0.5 to 2.0% by weight based on the core toner.

11. An image forming apparatus comprising:
an image carrying member, an electrostatic latent image is formed on the image carrying member, and a developing device that houses a developer containing a toner to develop the electrostatic latent image on the image carrying member, and a carrier to charge the toner,
the toner containing a core toner, and an external additive that is added to a surface of the core toner,
the core toner containing a colorant, a binder resin, a releasing agent, and a charge controlling agent containing Al and Mg, an amount of the charge controlling agent on the surface of the core toner being from 0.2 to 4.0 cps/eV in terms of a Mg amount measured by EDX, the core toner having a circularity of from 0.880 to 0.930,
the external additive having a primary particle diameter of from 70 to 200 nm, an amount of the external additive being from 0.2 to 3.0% by weight based on the core toner.

12. The image forming apparatus according to claim 11, wherein the core toner has a circularity of from 0.900 to 0.920.

13. The image forming apparatus according to claim 11, wherein the amount of the charge controlling agent on the surface of the core toner is from 1.0 to 3.0 cps/eV in terms of a Mg amount measured by EDX.

14. The image forming apparatus according to claim 11, wherein the external additive has a primary particle diameter of from 100 to 120 nm.

15. The image forming apparatus according to claim 11, wherein the amount of the external additive is from 0.5 to 2.0% by weight based on the core toner.

16. The image forming apparatus according to claim 11, wherein the external additive contains silica.

17. The image forming apparatus according to claim 11, wherein the charge controlling agent further contains Fe.

18. The image forming apparatus according to claim 11, wherein the charge controlling agent further contains Cr.

19. The image forming apparatus according to claim 11, wherein the charge controlling agent further contains Zr.

20. The image forming apparatus according to claim 11, wherein the developer comprises:
a toner, and a carrier to charge the toner,
the toner contains a core toner, and an external additive that is added to a surface of the core toner,
the core toner contains a colorant, a binder resin, a releasing agent, and a charge controlling agent containing Al and Mg, an amount of the charge controlling agent on the surface of the core toner is from 1.0 to 3.0 cps/eV in terms of a Mg amount measured by EDX, the core toner has a circularity of from 0.900 to 0.920,
the external additive has a primary particle diameter of from 100 to 120 nm, an amount of the external additive is from 0.5 to 2.0% by weight based on the core toner.
